(19) United States
(12) Patent Application Publication
(10) Pub. No.: US 2008/0043394 A1
(43) Pub. Date: Feb. 21, 2008

(54) Receptacle energized state indicator and circuit breaker trip apparatus

(76) Inventor: Albert Intenzo, Whitehouse Station, NJ (US)

Correspondence Address: Galasso & Associates, LP, P.O. Box 26503, Austin, TX, 78755-0503, US

(21) Appl. No.: 11/504,184

(22) Filed: Aug. 15, 2006

(51) Int. Cl. H02H 9/06

(52) U.S. Cl. 361/118

(57) ABSTRACT

A receptacle energized state indicator and circuit breaker trip apparatus is provided for testing a standard 120 volts AC electrical receptacle for the presence of electrical power and remotely tripping the circuit breaker or fuse on the circuit if desired. When it is necessary to work on a receptacle or the circuit wiring to a receptacle, it is important to know that the electrical power has been removed from the receptacle or circuit before beginning work. If the receptacle is energized, the receptacle energized state indicators of the apparatus illuminate to indicate the electrical service circuit is live. The receptacle does not need to be wired correctly for the apparatus to detect a live receptacle. If the receptacle is energized, the user may elect to attempt to de-energize the circuit and receptacle by inducing a very short duration over current condition into the circuit via operation of the circuit interruption means pushbutton. If the over current condition trips the distribution panel breaker or fuse, then the receptacle energized state lamps are extinguished in confirmation. If the breaker or fuse fails to trip and the receptacle remains live, then the receptacle energized state lamps remain illuminated to warn the user that the circuit remains live.

### CROSS REFERENCE TO RELATED APPLICATIONS

This application claims priority to co-pending U.S. Provisional Patent Application filed May 4, 2006 entitled “SHOCK PROOF”, having a common applicant herewith.

### FIELD OF THE DISCLOSURE

The disclosures made herein relate generally to utility AC power outlet electrical test apparatuses and, more particularly, to apparatuses for testing standard single phase 3-wire or 2-wire utility 120 volt AC power receptacles, screw type 120 VAC candelabra lamp sockets, as well as wiring terminations for determining the energized or de-energized state of the electrical supply circuit, as well as providing a switchable means of tripping the circuit breaker or fuse of the circuit under test.

### BACKGROUND

Within residential home and office buildings, interior walls are provided with single phase 3-wire 120 volt alternating current receptacles for providing electric utility generated power to electric consuming devices such as lamps, computers, appliances and the like. Some receptacles in older homes may be of the older 2-wire variety which lack a ground terminal in the receptacle. In homes and offices it can be very difficult to determine what particular circuit breaker or fuse at what particular circuit breaker panel or fuse box needs to be opened or switched off to de-energize a particular electrical receptacle. Sometimes the breaker tripped is not the correct breaker and the receptacle and circuit remains energized. When it is necessary to work on a receptacle or the circuit wiring to a receptacle, it is important to know that the electrical power has been removed from the receptacle or circuit before beginning work. Working on residential or commercial electrical wiring while it is ‘hot’ is dangerous and possibly life threatening due to the ever present risk of painfull or deadly electrical shock. Residential or commercial 120 volt AC circuits are protected by circuit breakers or fuses, typically having a rating of 15 or 20 amperes, the rating usually corresponding to the expected load of the circuit and the gauge of the electrical wiring used in wiring the circuit.

Conventional means of testing for the presence of power at an electrical receptacle such as plug-in types of electrical receptacle test devices, as well as voltmeters and other voltage testers have one or more drawbacks. One drawback is that they do not protect novice home improvement workers or the do-it-yourself type as well as professional electricians from hazardous and potentially deadly electrical shocks. Electricians may assume a receptacle is wired correctly and test for voltage between the hot and neutral contacts only when determining if the receptacle is energized. Another drawback is if the receptacle is found to be energized even though the breaker was thought to be tripped, the electrician or home owner my decide to proceed to work on the device ‘hot’ rather than seeking out the correct circuit breaker on the correct distribution panel or sub panel.

Therefore, an apparatus for determining the energized or de-energized state of the receptacle and providing a switchable means of remotely tripping the circuit breaker or fuse of the circuit under test, one which identifies receptacles which are still energized, an apparatus that can identify energized receptacles even if they are not properly wired, for example with the neutral connected to the hot terminal, and the hot lead to the neutral terminal, an apparatus that includes a user activatable circuit interruption means for tripping a breaker from the receptacle and remotely from the distribution panel, an apparatus that provides visual confirmation that the breaker has actually tripped and the receptacle is de-energized, an apparatus that is adapted for direct connection to 3-wire and 2-wires receptacles as well as for use with candelabra base screw type lamp sockets, an apparatus that is designed to provide a very short duty cycle short circuit to trip the breaker so as to minimize any chance of overheating or overstressing wiring, such an apparatus would be useful and novel.

### SUMMARY OF THE DISCLOSURE

In one embodiment of the inventive disclosures made herein, a receptacle energized state indicator and circuit breaker trip apparatus comprises a closed generally rectangular housing having a rear wall secured to the rear portion of the housing, with two (hot and neutral) or three (hot, neutral and ground) electrically conductive prongs extended outwards from the rear wall of the housing. In the present inventive disclosures the ground prong is retractable into the housing so as to adapt the apparatus for use on older 2-wire receptacles lacking a ground terminal. The prongs are positioned in a spaced parallel relationship and configured to permit removable insertion and electrically conductive engagement of the prongs into the electrical service terminals of a standard 120 volt alternating current electrical wall mount receptacle. The housing includes one or more electrically illuminated indicators for indicating when the receptacle is energized, the indicators mounting to the front portion of the housing. The illuminated indicators may comprise light emitting diode (LED) lamps, or neon lamps, or other varieties of illuminated indicators suitable or adaptable for service in 120 volt alternating current service, such lamps and indicators as would be known to those skilled in the art. The apparatus includes a circuit interruption means that is secured within the housing. The circuit interruption means is electrically connected to the hot, neutral and, if present, ground, service prongs. The circuit interruption means is adapted for tripping an over current safety trip means of the electrical service circuit, usually a circuit breaker or fuse located in a central electrical distribution breaker panel or sub panel. The means of tripping the breaker or fuse is by way of introduction of a momentary, very short duration electrical current overload in the circuit. The duration of the overload is time limited to limit the stress to the electrical circuit and limit any induced heating in the circuit, such as to avoid possibilities of a fire. If the circuit breaker or fuse fails to trip during the momentary overload, the receptacle energized state indicator and circuit breaker trip apparatus of the present inventive disclosure proceeds to quickly interrupt the overload to prevent overheating and stress on the conductors of the circuit. The circuit interruption means is activated by depressing an activation switch which is secured within the housing and accessible on the front face of the house near the circuit energized illuminated indicators discussed above. The housing includes an illuminating flash indicator means for indicating when the circuit interruption means is actively trying to trip the breaker. The flash indicator is secured within the housing and visible at the front portion of the housing near the activation pushbutton switch.

To use the receptacle energized state indicator and circuit breaker trip apparatus, the apparatus is inserted or plugged into a 120 volt alternating current service receptacle. If the receptacle is energized, the receptacle energized state indicators of the apparatus illuminate to indicate the electrical service circuit is live. The receptacle does not need to be wired correctly for the apparatus to detect a live receptacle. The presence of 120 volt hot and a ground on any two of the pins is sufficient to trigger the energized state illuminated indicators. If the receptacle is energized, the user may elect to attempt to de-energize the circuit and receptacle by inducing a very short duration over current in the circuit via operation of the circuit interruption means pushbutton. If the over current trips the distribution panel breaker or fuse as expected and intended, then the receptacle energized state lamps are extinguished, indicating power has been removed from the receptacle. If the breaker or fuse fails to trip and the receptacle remains live, then the receptacle energized state lamps remain illuminated to warn the user that the circuit remains live

A second embodiment of the inventive disclosures made herein, a receptacle energized state indicator and circuit breaker trip apparatus of the first embodiment is equipped to utilize a one pulse momentary contact pushbutton switch, wherein upon depressing the switch momentarily closes then opens a set of electrical contacts when the switch is depressed, and where the pushbutton switch must be released and then re-depressed to cause another momentary contact closure. It is understood that the use of dry contacts such as on mechanical switches for the use of switching substantial currents is generally not ideal due to arcing at the contacts that can result in minute vaporization of metal from the contact members. Arcing of the contacts tends to happen when the contact opens rather then when it closes, and so is not as significant of a problem as long as the circuit breaker or fuse trips during the time the contact remains closed. If the circuit fails to trip in that time, then some arcing around the contact can occur as the contacts open.

In a third embodiment a second embodiment of the inventive disclosures made herein, a receptacle energized state indicator and circuit breaker trip apparatus of the first embodiment is provided with a circuit interruption which means comprises a bidirectional silicon semiconductor switch device triggered by a voltage doubler circuit. The bidirectional silicon semiconductor switch device in one embodiment is a SIDAC which is a variety of thryristor having a unique set of properties. The SIDAC is a commercially available voltage triggered switch capable of passing current bidirectionally and providing a low resistance circuit to current flow when triggered. Use of a semiconductor device such as a SIDAC eliminates issues with mechanically switching heavy current loads as the load switching is performed by the SIDAC semiconductor device. The SIDAC is triggered to conduct current by an applied voltage exceeding the rated switch on voltage, and remains on until the current drops below a low current limit. This permits the SIDAC, once triggered, to remain on (circuit closed conducting current) for a maximum of one half wave of a 60 hertz power line wave form, after which time the SIDAC opens and stops conducting current. This characteristic of the SIDAC can be applied to create a very short duration over current condition through the receptacle to the electrical circuit, a duration short enough to limit stress and overheating the conductors. This momentary feature of the SIDAC is particularly useful from a safety view point if the apparatus fails to provide enough current flow to trip the circuit breaker or fuse, as the induced short or overload is quickly removed from the electrical circuit. SIDACs are readily available to pass inrush currents of 20 amperes, and are available in switch point voltages of at least between 95 volts and 330 volts. For one illustrative example, on 120 VAC service, a SIDAC having a switch point voltage of 200 volts is servicable for this disclosed embodiment. A switch on voltage of greater than or equal to 200 volts must be applied to activate the SIDAC, this higher voltage is obtained by the voltage doubler circuit which doubles the incoming line voltage to trigger the SIDAC.

In another embodiment, a method of determining the energized state of an electrical service receptacle and remotely tripping a circuit breaker or fuse to de-energize the circuit comprises connecting a circuit energized state indicator and manual circuit trip apparatus to an electrical service receptacle; determining the energized state of the receptacle by observation of receptacle energized state indicators; operating a pushbutton to trigger a circuit interruption means; de-energizing the receptacle by inducing a short duration over current into the circuit through the circuit interruption means; then confirming that the receptacle is de-energized by observation of the receptacle energized state indicators. If the circuit remains energized as indicated by the energized state indicator, then the user may elect to retry interrupting the electrical power to the receptacle by proceeding at the operating a pushbutton step above. Once the energized state indicators are extinguished indicating the receptacle is de-energized then disconnecting the circuit energized state indicator and manual circuit trip apparatus from the electrical service receptacle.

It is an objective of the inventive disclosure made herein to provide a receptacle energized state indicator and circuit breaker trip apparatus which is designed to identify electrical service receptacles which are energized.

It is another objective of the inventive disclosure made herein to provide a receptacle energized state indicator and circuit breaker trip apparatus that can identify energized receptacles even if the receptacles under test are not properly wired, for example with the neutral connected to the hot terminal, or the hot lead to the neutral terminal, or some similar variation of incorrect wiring.

It is another objective of the inventive disclosure made herein to provide a receptacle energized state indicator and circuit breaker trip apparatus that includes a user activatable circuit interruption means for remotely tripping a circuit breaker or fuse of the circuit supplying power to the receptacle.

It is another objective of the inventive disclosure made herein to provide a receptacle energized state indicator and circuit breaker trip apparatus that provides visual confirmation that the breaker has actually tripped and the receptacle is de-energized.

It is another objective of the inventive disclosure made herein to provide a receptacle energized state indicator and circuit breaker trip apparatus that is designed to provide a very short duty cycle short circuit to trip the breaker so as to reduce the chance of overheating or overstressing wiring.

It is another objective of the inventive disclosure made herein to provide a receptacle energized state indicator and circuit breaker trip apparatus that is adapted for use on 120 volts 3-wire receptacles, as well as for use on older standard 120 volt 2-wire receptacles which lack the ground terminal.

It is another objective of the inventive disclosure made herein to provide a receptacle energized state indicator and circuit breaker trip apparatus that is adapted for use on 120 volt candelabra base screw type lamp or light sockets such as found in room ceiling lamps.

It is another objective of the inventive disclosure made herein to provide a receptacle energized state indicator and circuit breaker trip apparatus that is additionally adapted for use with alligator clip type connections to live electrical circuits.

It is another objective of the inventive disclosure made herein to provide a receptacle energized state indicator and circuit breaker trip apparatus that is designed to provide a very short duty cycle short circuit to trip the breaker so as to reduce the chance of overheating or overstressing wiring.

These and other objects of the invention made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of the rear and side of one embodiment of the receptacle energized state indicator and circuit breaker trip apparatus in accordance with the inventive disclosures herein.

FIG. 2 depicts a perspective view of the front and side of one embodiment of the receptacle energized state indicator and circuit breaker trip apparatus in accordance with the inventive disclosures herein.

FIG. 3 depicts a circuit schematic of one embodiment of a circuit interruption means in accordance with the inventive disclosures herein, the illustrated embodiment depicting a bidirectional silicon semiconductor switch device triggered by a voltage doubler circuit.

FIG. 4 depicts a circuit schematic of one embodiment of the illuminated receptacle energized state indicators of a receptacle energized state indicator and circuit breaker trip apparatus in accordance with the inventive disclosures herein.

FIG. 5 depicts a perspective view of the an adapter for use with receptacle energized state indicator and circuit breaker trip apparatus, the adapter removably connectable to the electrical prongs on the circuit breaker trip apparatus and providing alligator clip terminated electrical leads for direct connection to electrical circuits without use of a receptacle or a candelabra base screw type lamp or light socket.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

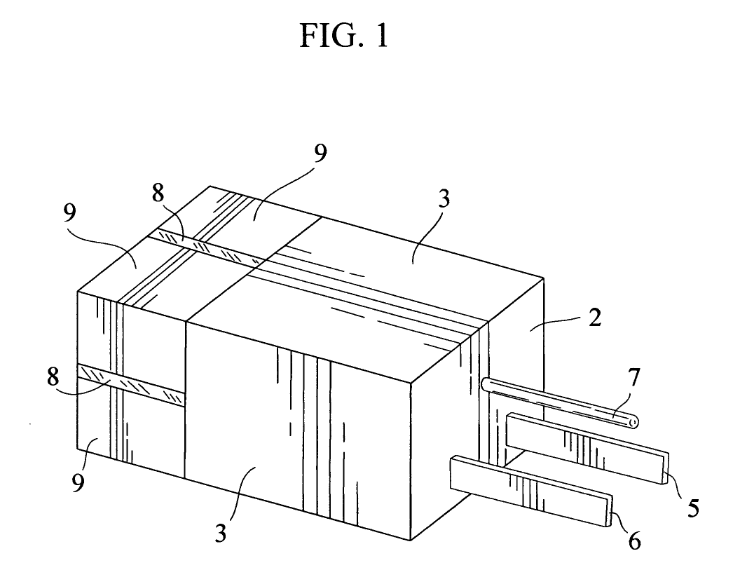

FIG. 1 depicts a perspective view of the rear and side of one embodiment of the receptacle energized state indicator and circuit breaker trip apparatus in accordance with the inventive disclosures herein. The receptacle energized state indicator and circuit breaker trip apparatus 1 comprises a block-like rectangular shaped body having a rear wall 2 and periphery sidewalls 3. Three male electrically conductive prongs extending outwards from the rear wall in the rear portion of the housing and comprise generally a hot 5, neutral 6 and ground 7 prong, where the terms hot, neutral and ground are terms used by and known by those skilled in the art of electrical work and defined in the National Electrical Code, among other places. The prongs 5, 6, and 7 are spaced and configured to permit removable ready insertion and electrically conductive engagement of the prongs with respective hot, neutral, ground service terminals of a conventional three conductor grounded electrical receptacle. The ground prong 7 is retractable into the housing to adapt the apparatus for use on old type 2-wire 120 volt receptacles which lack a ground terminal. The housing has a plurality of electrically illuminated receptacle energized state indicators 8, one or more of which illuminate when the receptacle into which the apparatus is electrically connected is energized. Flash indicators 9 illuminate to indicate when the circuit interruption means is activated.

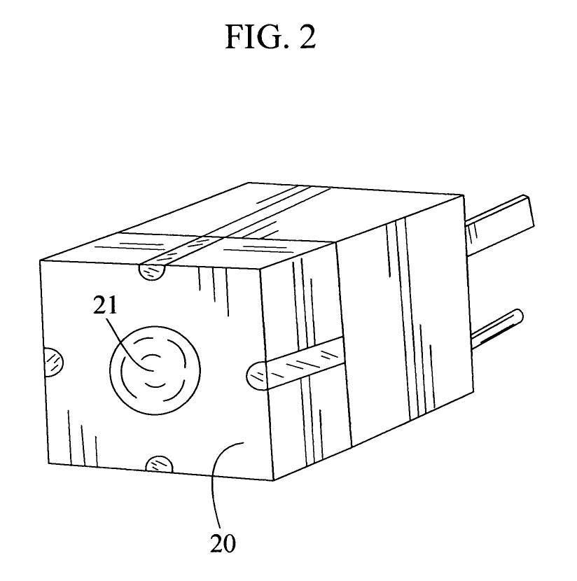

FIG. 2 depicts a perspective view of the front and side of one embodiment of the receptacle energized state indicator and circuit breaker trip apparatus in accordance with the inventive disclosures herein. The housing has a front wall 20 and periphery side walls. A pushbutton member 21 is mounted in the front wall 20 of the housing. The pushbutton 21 operates an activation switch secured within the housing and electrically connected to the circuit interruption means.

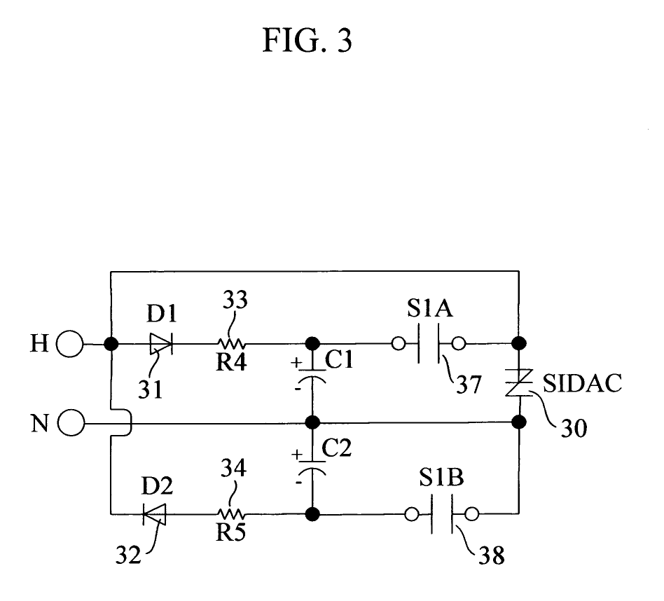

FIG. 3 depicts one possible circuit schematic of one embodiment of a circuit interruption means in accordance with the inventive disclosures herein, the illustrated embodiment depicting a bidirectional silicon semiconductor switch device 30 triggered by a voltage doubler circuit. The silicon semiconductor switch device 30 in the illustrated embodiment is a SIDAC. Use of a semiconductor device such as a SIDAC eliminates issues with mechanically switching heavy current loaded as the load switching is performed by the SIDAC semiconductor device. The SIDAC is triggered to conduct current by an applied voltage exceeding the rated switch on voltage of the SIDAC, and the SIDAC remains on until the current drops below a low current limit. This permits the SIDAC, once triggered, to remain on (circuit closed conducting current) for a maximum of one half wave of a 60 hertz power line wave form, after which time the SIDAC opens and stops conducting current. This characteristic of the SIDAC can be applied to create a very short duration over current condition through the receptacle to the electrical circuit, a duration short enough to limit stress and overheating the conductors. This momentary feature of the SIDAC is particularly useful from a safety point of view, particularly if the apparatus fails to provide enough current flow to trip the circuit breaker or fuse, in which case the induced short or overload is quickly removed from the electrical circuit. SIDACs are readily available to pass inrush currents of 20 amperes and are available in switch point voltages of at least between 95 volts and 330 volts. For one illustrative example, on 120 VAC service, a SIDAC having a switch point voltage of 200 volts is servicable for this disclosed embodiment. A voltage double circuit generates and stores a trigger voltage sufficiently above line voltage to one shot trigger the SIDAC into a conducting state. The illustrated voltage doubler circuit consists of diode rectifiers 31 and 32, in series with charging current limiting resistors 33 and 34. The diodes rectify the alternating current electrical supply through the host and neutral connections, passing a positive half of the AC waveform through rectifier 31 and resistor 33 to charge trigger voltage storage capacitor 35. The negative half of the AC waveform is rectified through diode 32 and current limit resistor 34 to charge trigger voltage storage capacitor 36. Trigger voltage storage capacitors 35 and 36 are charged individually but discharge in series such that their voltage is doubled or somewhat near the peak value of the incoming electrical circuit line voltage. This doubled voltage is applied to the SIDAC 30 through switch contacts 37 and 38 to initially and one shot trigger the SIDAC into conducting current from the hot prong to the neutral prong so as to effect a very short duration over current of the electrical circuit feeding the receptacle with the goal of tripping the circuit breaker. Contacts 37 and 38 close and open in unison and are actuated by the activation pushbutton discussed earlier. Contacts 37 and 38 close to one shot trigger the SIDAC to conduct current. Tracing the schematic one can observe that the SIDAC is connected directly across the hot and neutral supply connections such that, when triggered to conduct, the SIDAC can affect a low resistance current shunt between the hot and neutral. Again, the conducting period of the SIDAC is very short, not exceeding half a wavelength of the 60 Hz power line. It is to be understood that the invention is not limited to the use of sold state switching devices such as SIDACs, but can be realized by use of direct acting mechanical or wetted contact switches or devices actuated by the pushbutton, leading to a simpler design. Such direct mechanical contacts upon closing shunt current between the hot and neutral and thereby induce the over current condition to trip the breaker. The SIDAC design is presented as one enabling embodiment of the inventive disclosures herein.

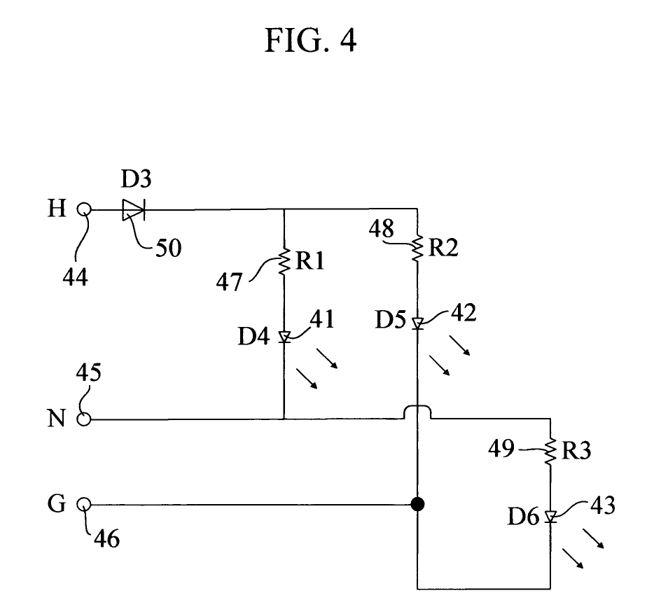

FIG. 4 depicts a circuit schematic of one particular embodiment of the illuminated receptacle energized state indicators of a receptacle energized state indicator and circuit breaker trip apparatus in accordance with the inventive disclosures herein. Other embodiments are envisioned, such as embodiments which illuminate all the energized state indicators simultaneously. The illustrated embodiment provides a schematic of one embodiment which illuminates energized state indicators individually according to which electrical plug prong pairs have electrical supply circuit voltages across the pair. In the depicted embodiment, energized state indicators 41, 42 and 43 are light emitting diodes (LEDs). Each LED is connected to receive power from two of three plug prongs, specifically the hot 44, neutral 45 and ground 46 prongs terminals of the disclosed apparatus. Diode 50 rectifies the current between hot and neutral or hot and ground. Receptacle energized state indicator 41 illuminates when the hot 44 and neutral 45 are at differing electrical potentials indicating power is applied to the receptacle under test. Receptacle energized state indicator 42 illuminates when the hot 44 and ground 46 are at differing electrical potentials indicating power is applied to the receptacle under test. Receptacle energized state indicator 43 illuminates when the neutral 45 and ground 46 are at differing electrical potentials indicating power is applied to the receptacle under test and that the circuit or receptacle is incorrectly wired, as the ground and neutral should normally be of nearly equal potential. Resistors 47, 48 and 49 have a resistance which is selected using Ohms law to limit current to the LEDs to no more than 20 mA so as to prevent exceeding the current rating of the LED lamps 41, 42 and 43.

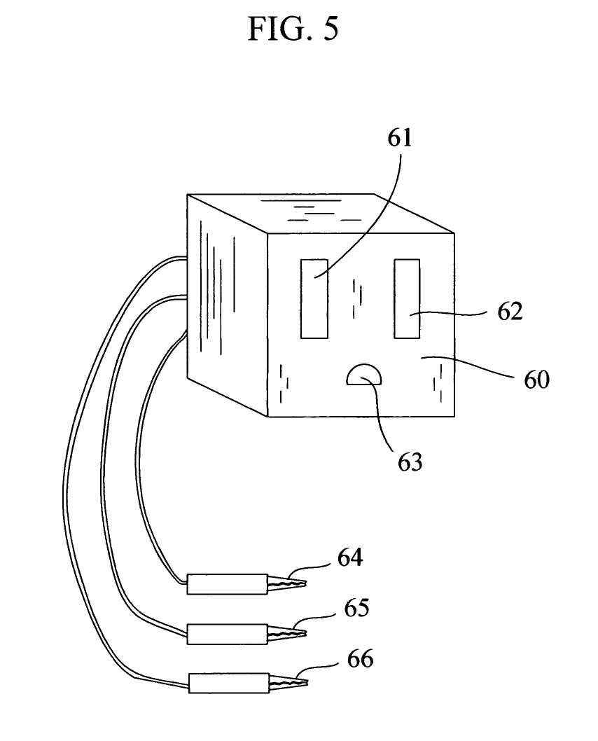

FIG. 5 depicts a perspective view of the an alligator clip circuit test adapter for use with receptacle energized state indicator and circuit breaker trip apparatus, the adapter removably connectable to the electrical prongs on the circuit breaker trip apparatus and providing alligator clip terminated electrical leads for direct connection to electrical circuits without use of a receptacle or a candelabra base screw type lamp or light socket. The face of the adapter 60 has recessed receptacle terminals for the neutral 61, hot 62 and ground 63 configured to receive the neutral, hot and ground terminals of the receptacle energized state indicator and circuit breaker trip apparatus. Three electrical leads terminating in alligator clips having an insulating sheath extend through the back wall of the adapter. The adapter is removably connectable to the electrical prongs on the circuit breaker trip apparatus and providing alligator clip terminated electrical leads for direct connection to electrical circuits without use of a receptacle or a candelabra base screw type lamp or light socket. The adapter has no active components, but merely provides an adapter housing having a receptacle to engage with the prongs on the circuit breaker trip apparatus and electrically connect to the alligator clip terminated leads 64, 65 and 66. The alligator clip terminated leads are color coded to match the wire insulation color coding of the National Electrical Code in which the ground lead 64 is green, the hot lead 65 is white and the neutral lead 66 is black.

The discussed construction, illustrations and sequence of operation is for one embodiment of the invention but is in no way limiting to other embodiments. The operating modes may be changed and enhanced without deviating from the intention of this inventive disclosure.

In the preceding detailed description, reference has been made to the accompanying drawings that form a part hereof and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, electrical, component, schematic and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents as can be reasonably included within the spirit and scope of the appended claims.

What is claimed is:

1. A circuit energized state indicator and manual circuit trip apparatus for use with an electrical service receptacle having hot, neutral and possibly ground service terminal, the apparatus comprising:
a housing having a front portion and a rear portion, the housing having:
a rear wall secured to the rear portion of the housing;
an opposing front wall secured to the front portion of the housing; and
one or more periphery sidewalls, the sidewalls attached along edges to the walls of the housing such that the walls form a closed shaped;
two male electrically conductive prongs extending outwards from the rear wall in the rear portion of the housing, the prongs in a spaced parallel relationship;
a retractable male electrically conductive ground prong extending outwards from the rear wall in the rear portion of the housing, the ground prong in a spaced parallel relationship to the hot and neutral prongs, the prongs spaced and configured to permit removable insertion and electrically conductive engagement of the prongs with respective hot, neutral, ground service terminals of the receptacle; the ground prong retractable into housing to adapt the circuit trip apparatus for use on older 2 wire receptacles lacking a ground terminal;
one or more electrically illuminated receptacle energized state indicators for indicating when the receptacle is energized, the indicators mounting to the housing and visible from the front portion of the housing;
a circuit interruption means secured within said housing, the circuit interruption means electrically connected to said hot and neutral service prongs, the means adapted for tripping an over current safety trip means electrical service circuit connected to the receptacle;
an activation switch secured within the housing and electrically connected to the circuit interruption means;
an illuminating flash indicator means for indicating when the circuit interruption means is active, the flash indicator secured within the housing and visible at the front portion of the housing; and
a pushbutton member mounted in the front wall of the housing and engaging the switch, the pushbutton member configured to operate the switch when depressed, wherein the apparatus is insertable into a service receptacle, the apparatus indicators illuminating to indicate the electrical service circuit is live, the circuit interruption means pushbutton operable to trip the over current safety trip means, the indicators extinguishing to confirm electrical service is removed from the receptacle.

2. The circuit energized state indicator and manual circuit trip apparatus of claim 1, wherein depressing the activation switch provides a short duration momentary electrical contact closure; and wherein the switch must be released then re-depressed to achieve another momentary closure.

3. The circuit energized state indicator and manual circuit trip apparatus of claim 2, wherein the housing has a rectangular shape.

4. The circuit energized state indicator and manual circuit trip apparatus of claim 1, wherein the circuit interruption means comprises a momentary one shot switchable current shunt means.

5. The circuit energized state indicator and manual circuit trip apparatus of claim 4, wherein the circuit interruption means comprises a bidirectional silicon semiconductor switch device, the semiconductor switch device providing a short ontime duration switchable low resistance shunt to passage of current between the hot and neutral; and wherein the flash indicator comprises light emitting diodes.

6. The circuit energized state indicator and manual circuit trip apparatus of claim 5, wherein the bidirectional silicon semiconductor switch device comprises a SIDAC triggered by a voltage doubler circuit.

7. The circuit energized state indicator and manual circuit trip apparatus of claim 5, wherein the housing has a rectangular shape.

8. The circuit energized state indicator and manual circuit trip apparatus of claim 5 further having an alligator clip circuit test adapter comprising:
a housing with a three terminal receptacle on a front face, the three terminal receptacle for removably and electrically engaging the electrical prongs of the apparatus;
three insulated electrical leads extending outwards from a back face of the adapter, one for hot one for neutral and one for ground, each lead terminated on one end with an electrical alligator clip, each lead electrically and uniquely connected to a corresponding receptacle terminal in the adapter housing.

9. The circuit energized state indicator and manual circuit trip apparatus of claim 8, wherein the insulation of the electrical leads is color coded such that the ground lead has green insulation, the hot lead black insulation and the neutral lead has white insulation.

10. The circuit energized state indicator and manual circuit trip apparatus of claim 5 further having a candelabra base screw type lamp socket adapter comprising:
a receptacle on a front face, the terminals of the receptacle for removably and electrically engaging the electrical prongs of the apparatus;
a base portion of the lamp socket adapter having standard threaded electrical lamp base secured thereon, the lamp base sized and configured to be electrically received into a conventional candelabra screw type lamp socket, the terminals on the lamp socket adapter electrically connected to the electrical lamp base of the lamp socket adapter.

11. A method of determining the energized state of an electrical service receptacle and remotely tripping a circuit breaker or fuse to de-energize the circuit, which comprises:
connecting a circuit energized state indicator and manual circuit trip apparatus to an electrical service receptacle;
determining the energized state of the receptacle by observation of receptacle energized state indicators;
operating a pushbutton to trigger a circuit interruption means;
de-energizing the receptacle by inducing a short duration over current into the circuit through the circuit interruption means;
confirming that the receptacle is de-energized by observation of the receptacle energized state indicators, if the circuit is energized then continuing at the operating step; and
disconnecting the circuit energized state indicator and manual circuit trip apparatus from the electrical service receptacle.
